(19) United States
(12) Patent Application Publication
(10) Pub. No.: US 2024/0324593 A1
(43) Pub. Date: Oct. 3, 2024

(54) OCTENIDINE COMPOSITIONS AND METHODS OF USE THEREOF

(71) Applicant: Solventum Intellectual Properties Company, Maplewood, MN (US)

(72) Inventors: Rajan B. Bodkhe, Woodbury, MN (US); Matthew T. Scholz, Woodbury, MN (US)

(21) Appl. No.: 18/578,783

(22) PCT Filed: Jul. 21, 2022
(86) PCT No.: PCT/IB2022/056761

§ 371 Date: Jan. 12, 2024

Related U.S. Application Data
(60) Provisional application No. 63/225,044, filed on Jul. 23, 2021.

(51) Int. Cl. A01N 43/40; A01N 37/44; A01P 1/00

(52) U.S. Cl. CPC A01N 43/40; A01N 37/44; A01P 1/00

(57) ABSTRACT

Aqueous antimicrobial compositions including an octenidine salt and carnitine tartrate, and articles containing the same, are described. Methods and kits for preventing or reducing symptoms of infection and disinfecting surfaces are further described.

### BACKGROUND

One of the primary functions of skin is to offer protection from microbial infections. Subcutaneous tissues, which are exposed when the skin is broken, provide an environment suitable to microbial colonization and proliferation. Most infections are caused by Staphylococcus aureus (20%), Staphylococcus epidermidis (14%), Enterococci spp. (12%), Escherichia co/i (8%), Pseudomonas aeruginosa (8%), Enterobacter spp. (7%), Proteus spp. (3%), Klebsiella pneumoniae (3%), Streptococci (3%) and Candida albicans (3%), and all instances of broken skin pose some risk to infection. Mucosal tissues in nasal passages, anterior nares, the vagina, or the like, may also harbor bacteria. Even in the absence of wound, tissues harboring bacteria may lead to a localized or systemic infection. For example, bacteria present in nasal passages have been known to lead to surgical-site infections by contaminating the surgical environment. Further, for example, it is common for bladder infections to result from bacteria in and around the vagina entering the urethra upon catheterization.

Wounds often have multiple barriers to healing. Healing is influenced by the relationship between the ability of bacteria to create a stable community within a wound environment and the ability of the host to control the bacterial community. Declining overall health affects the ability to control infections and allows for bacteria to establish protective biofilms. Patients are often given antibiotics in efforts to combat infections; however, many bacteria have developed resistance to antibiotics, especially bacterial infections acquired in a hospital setting (e.g., surgical site infections).

Antibiotic resistance and the inability to ward off infection contributes to the financial burden associated with wound care. Estimated Medicare costs for acute and chronic (non-healing) wound treatments range from $28 billion to $97 billion and about 2% of the U.S. population suffers from such chronic wounds, which are commonly associated with stress, malnutrition, diabetes, and other metabolic syndromes.

Use of topical antimicrobial agents is currently the primary strategy for preventing and treating infections, particularly with regard to chronic wounds. However, the potential for cellular toxicity with use of many antiseptics must be considered, especially when long-term treatment is required. While a variety of antimicrobial compositions and articles are available, continued development of new formulations are required to offset various deficiencies and shortcomings to allow for better treatment plans.

Octenidine hydrochloride (“octenidine”) was introduced for skin, mucous membrane and wound antisepsis more than 20 years ago. Nowadays, octenidine represents an alternative to older substances such as chlorhexidine, povidone-iodine, and triclosan, and is rapidly gaining acceptance as a broad-spectrum antimicrobial for use in disinfection, antisepsis, and decolonization in health-care settings. Octenidine is not absorbed through skin or mucous membranes, does not cause contact dermatitis, and no reports indicate reduced susceptibility. Octenidine has no apparent toxicity, unlike other cationic biocides, and has been shown to be less cytotoxic than chlorhexidine. In fact, the antimicrobial efficacy for octenidine is about 3-10 times higher than chlorhexidine.

The battle against infection requires continued effort to develop suitable antimicrobial compositions. The present disclosure is focused on enhancing the antimicrobial efficacy of octenidine, particularly with carnitine tartrate.

### SUMMARY

In one embodiment, an antimicrobial composition is described. The antimicrobial composition includes an octenidine salt, carnitine tartrate, and water.

In one embodiment, an antimicrobial article is described. The antimicrobial article includes a substrate and an antimicrobial composition disposed on or within the substrate. The antimicrobial composition includes an octenidine salt, carnitine tartrate, and water.

In one embodiment, a method for preventing an infection or treating an infection in a subject is described. The method includes contacting an antimicrobial composition or antimicrobial article to a body surface and allowing the antimicrobial composition to contact the body surface for a period effective to reduce the presence of infection-promoting microorganisms. The antimicrobial composition includes an octenidine salt, carnitine tartrate, and water.

In one embodiment, a method for disinfecting or decolonizing a surface is described. The method includes contacting an antimicrobial composition to a surface and allowing the antimicrobial composition to contact the surface for a period effective to reduce the presence of microorganisms. The antimicrobial composition includes an octenidine salt, carnitine tartrate, and water.

In one embodiment, a kit is described. The kit includes an antimicrobial composition and a set of instructions directing a user to contact a surface with the antimicrobial composition.

In one embodiment, a kit is described. The kit includes an octenidine salt and carnitine tartrate provided together as powder or a concentrate. The kit further includes a set of instructions directed a user to the contact the powder or concentrate with water to form an antimicrobial composition.

### DETAILED DESCRIPTION

The present disclosure is directed toward aqueous octenidine-based antimicrobial compositions that are formulated with carnitine tartrate. Surprisingly, it was found that the present of carnitine tartrate significantly improves the antimicrobial activity of octenidine hydrochloride compared to compositions with either octenidine or carnitine tartrate alone. Even more surprising, is that the activities of other common antimicrobials (e.g., chlorhexidine gluconate, quaternary ammonium salts like benzalkonium chloride and polyhexamethylene biguanide) were not enhanced by carnitine tartrate.

The compositions of the present disclosure are effective in reducing, preventing, and eliminating microbes, particularly bacteria, fungi, and viruses. The compositions are useful when applied topically, particularly to mucosal tissues (i.e., mucous membranes), skin, and wounds, although a wide variety of surfaces can be treated. Furthermore, the compositions of the present disclosure do not require high concentrations of octenidine to be effective, as compared to other commercial octenidine compositions, thus the chances that a subject may experience local irritation or cytotoxicity is lessened.

L-Carnitine (i.e., (CH₃)₃N⁺—CH₂CH*(OH)CH₂CO₂—) exists as a zwitterionic compound having a quaternary ammonium moiety and a carboxylate. L-Carnitine is commonly referred to as an “inner salt.” Carnitine tartrate (i.e., 2(CH₃)₃N⁺—CH₂CH*(OH)CH₂CO₂H+⁻O₂CCH(OH)CH(OH)CO₂⁻), like many other carnitine salts, is commonly referred to as an “outer salt.” Carnitine outer salts include a protonated carboxyl moiety (i.e., a carboxylic acid) and a separate (outer) anionic species, e.g., tartrate.

Both L-carnitine (inner salt) and carnitine tartrate (outer salt) were discovered to show synergistic antimicrobial activity with octenidine, though the effect was significantly, and unexpectantly, greater for carnitine tartrate. Interestingly, other salts were shown to be completely ineffective, such as acylated carnitine (inner salt) and carnitine fumarate (outer salt). Acylated carnitine and carnitine fumarate both resulted in the precipitation of octenidine.

Currently, it is unclear why some carnitine salts greatly enhance the antimicrobial activity of octenidine while others seem to inactivate octenidine. Furthermore, it is unclear why carnitine tartrate fails to enhance antimicrobial activity when formulated with other antimicrobials. Continued work will lead to further understanding.

### Definitions

As used herein, “about” means ±10 percent of a given value. For example, about 10 means 9 to 11.

As used herein, a “concentrate” refers to a composition having less than 1 wt % water.

As used herein, “disinfect” refers to a reduction in the number of microorganisms present on a surface. If the surface is a body surface, the term “decolonize” may be synonymous with “disinfect.” Decolonizing a surface refers to reducing a number of microorganisms on a body surface (e.g., skin, tissue, mucosal tissue, etc.) wherein the microorganisms do not necessarily cause immediate clinical symptoms. Thus, methods for disinfecting surfaces may also include methods for decolonization.

As used herein, “hydrophilic” is a term that characterizes compounds that are water-soluble or water-dispersible.

As used herein, “hydrophobic” is a term that characterizes compounds that are not water-soluble or water-dispersible.

As used herein, the phrase “one or more of” such as used in the phrase “one or more of A and B” or “one or more of at least one A and at least one B” means a composition may include at least one A, more than one A, at least one B, more than one B, at least one A and at least one B, more than one A and more than one B. In other words, the phrase is not intended to mean the composition must have at least one of each of A and B.

As used herein, “prevention” refers to reducing microbial load so as to lessen the likelihood that a subject will endure an infection due to the presence of microbes.

As used herein, “salt” refers to an ionic chemical species having a cation and an anion. An octenidine salt is a protonated form of octenidine (i.e., cation) having a pharmaceutically-acceptable anion, e.g., chloride, acetate, or the like.

As used herein, “subject” refers to humans, sheep, horses, cattle, pigs, dogs, cats, rats, mice, or other mammals.

As used herein, “treatment” refers to reducing microbial load such that a subject experiences an alleviation of symptoms associated with a condition associated with infection caused by microbe. Symptoms of an infection may include redness, inflammation, pus, exudate, fever, aches, and the like.

As used herein, “wound” refers to an injury to a subject which involves a break in the skin or mucosal tissue barrier. Wounds may be caused, for example, by lacerations, surgery, burns, pressure sores, and the like. Wounds are to be understood to include both acute and chronic wounds.

As used herein, “water-dispersible” refers to the characterization of a material that will disperse in deionized water at a temperature of about 23° C. in an amount of at least 5 wt %. The material is considered dispersed if the mixture appears cloudy without phase separation or sedimentation after thoroughly mixing at 60° C. for 4 h and cooling to 23° C. for 24 h. A material that is not water-dispersible will exhibit sediment and/or phase separation at 5 wt % or greater under the same conditions.

As used herein, “water-soluble” refers to the characterization of a material that will dissolve in deionized water at a temperature of about 23° C. in an amount of at least 5 wt %. The material is considered dissolved if the solution appears clear (i.e., no visible cloudiness, phase separation, or precipitate) after thoroughly mixing at 60° C. for 4 h and cooling to 23° C. for 24 h. A solution sample exhibits at least 70% transmission at a wavelength of 655 nm at a path length of 4 cm in a lxi cm cell. A material that is not water-soluble will exhibit cloudiness, phase separations, precipitate, and/or sedimentation at 5 wt % or greater under the same conditions.

### Antimicrobial Compositions

In many embodiments, an antimicrobial composition is described. The antimicrobial composition may include an octenidine salt, carnitine tartrate, and water. In some embodiments, the antimicrobial composition may consist essentially of octenidine salt, carnitine tartrate, and water. In many embodiments, the octenidine salt may be octenidine hydrochloride.

In some embodiments, the antimicrobial composition may be in a form of a solution, a gel, an emulsion, a suspension, a colloid, a dispersion, cream, ointment, or a film. Various additional components may be incorporated within the composition in order to achieve a desired form or a deliverable modality (e.g., spray or aerosol spray). For example, the antimicrobial composition may further include one or more of a viscosity modifying agent (e.g., for preparing gels and other formulations of increased viscosity), an emollient, a surfactant (e.g., for preparing emulsions, gels, or suspensions), an emulsifier, an oil (e.g., mineral oils, silicone, vegetable oils, animal fats, and the like; e.g., for preparing emulsions, ointments, or creams), or the like. Further, for example, the antimicrobial composition may further include one or more film-forming components, such as water-soluble or water-dispersible polymers. Adjusting properties such as surface persistence (e.g., adhering to tissues vs. wound washes), moisture retention, volatility, and the like, are envisioned and readily obtainable through known formulation modifications. Those skilled in the art may readily determine modifications required to produce antimicrobial compositions in a variety of forms.

In some embodiments, the antimicrobial compositions described herein may be suitable as wound washes or other forms of wound care, formulations for surgical-site and intravenous preparation, formulations for decolonizing of mucosal linings (e.g., nasal decolonization to reduce spread of infectious microorganisms, vaginal decolonization to reduce catheter-related infections, or the like), hand sanitizers, sprays or cleaners for surface disinfection, and the like. In some embodiments, the antimicrobial compositions may be formulated (e.g., with hydrophobic components) to resist being washed away or otherwise rubbed off in the presence of bodily fluids, e.g., mucus, discharge, blood, sweat, tears, or the like. In other embodiments, the antimicrobial compositions may be formulated (e.g., with hydrophilic components) to not resist being rinsed or otherwise removed from surfaces.

In some embodiments, the antimicrobial composition may include octenidine salt (e.g., hydrochloride) present in an amount of about 0.05 wt % to about 20 wt % with respect to the weight of the composition. For example, octenidine salt may be present in an amount in wt % of about 0.05, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.5, 6.0, 6.5, 7.0, 7.5, 8.0, 8.5, 9.0, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or a value within a range between any of the preceding values, e.g., between about 3.4 and about 3.6, between about 2.0 and about 4.0, or the like.

In some embodiments, the antimicrobial composition may include carnitine tartrate present in an amount of about 0.05 wt % to about 50 wt % with respect to the weight of the composition. For example, carnitine tartrate may be present in an amount in wt % of about 0.05, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 6.0, 7.0, 8.0, 9.0, 10, 12, 14, 16, 18, 20, 22, 24, 26, 28, 30, 32, 34, 36, 38, 40, 42, 44, 46, 48, or 50, or a value within a range between any of the preceding values, e.g., between about 1.6 and about 3.0, between about 2.4 and about 4.6, or the like.

In some embodiments, the antimicrobial composition may include octenidine salt (e.g., hydrochloride) and carnitine tartrate present in a wt % ratio of about 10:1 to about 1:10. For example, octenidine salt and carnitine tartrate may be present in a wt % ratio of about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, or 1:20, or a ratio between any of the preceding values, e.g., between about 5:1 and about 1:1, between about 1:8 and about 1:12, or the like. In some embodiments, an antimicrobial composition including an octenidine salt, carnitine tartrate, and water may be in the form of a solution (i.e., homogenous) at an octenidine salt to carnitine tartrate wt % ratio of about 1:10 or greater. In some embodiments, an antimicrobial composition consisting essentially of an octenidine salt, carnitine tartrate, and water may be in the form of a solution (i.e., homogenous) at an octenidine salt to carnitine tartrate wt % ratio of about 1:10 or greater. It should be understood that all octenidine salt present need not be dissolved (e.g., a suspension, emulsion, or the like) to provide an effective antimicrobial composition. In some embodiments, the antimicrobial composition may include at least 0.05 wt %, at least 0.1 wt %, at least 0.15 wt %, at least 0.2 wt %, at least 0.3 wt %, at least 0.4 wt %, or at least 0.5 wt % solubilized (i.e., dissolved) octenidine salt.

In some embodiments, the antimicrobial composition may include water present in amount of about 30 wt % to about 99 wt % with respect to the weight of the composition. For example, water may be present in the antimicrobial composition in an amount in wt % of about 30, 35, 40, 45, 50, 55, 60, 65, 70, 75, 80, 85, 90, 95, 96, 97, 98, or 99, or a value within a range between any of the preceding values, e.g., between about 40 and about 50, between about 45 and about 60, or the like. In other embodiments, such as those intended to have a viscosity higher than that of water, the antimicrobial composition may include water present in an amount of about 5 wt % to about 75 wt %. Glycerol, for example, may be included in an amount up to 90 wt % to increase the viscosity of the composition.

In some embodiments, the antimicrobial composition may further include a hydrophilic compound. In many embodiments, a hydrophilic compound may include more than one hydroxyl group (i.e., a polyol), an ether, an ester, or a combination thereof. Suitable hydrophilic components include, for example, glycerin, polyglycerol-3, polyglycerol-6, polyglycerol-10, glycols (e.g., ethylene glycol, diethylene glycol, propylene glycol, butylene glycol, polyethylene glycol, polyethylene glycol 200 to 6000 molecular weight, block copolymers of ethylene oxide and propylene oxide, and the like), silicone polyols, pentaerythritol, trimethylolpropane, trimethylolethane, trimethylolbutane, sorbitol, maltitol, xylitol, pantothenol, 1,3-butanediol, diglycerine, polyglycerin, erythritol, sorbitan sugars, sugar alcohols, diemthylisosrobide, triacetin, methyl acetate, methyl lactate, ethyl lactate esters, or the like. Hydrophilic compounds may be present in an amount of about 0 wt % to about 90 wt %. For example, one or more hydrophilic compound may be present in amount in wt % of about 0, 5, 10, 15, 20, 25, 30, 40, 50, 60, 70, 80, or 90, or a value within a range between any of the preceding values, e.g., between about 5 and about 10, between about 50 and about 60, or the like.

In some embodiments, the antimicrobial composition may further include a hydrophobic compound. Suitable hydrophobic compounds include oils, fats, jellies (e.g., petrolatum), or the like, e.g., short chain (i.e., C1-C6) alkyl or C6-C12) aryl esters of long (i.e., C8-C36) straight or branched chain alkyl or alkenyl alcohols or acids and polyethoxylated derivatives of the alcohols; short chain (i.e., C1-C6) alkyl or (C6-C12) aryl esters of (C4-C12) diacids or diols optionally substituted in available positions by —OH; (C2-C18)alkyl or (C6-C12) aryl esters of glycerol, pentaerythritol, ethylene glycol, propylene glycol, as well as polyethoxylated derivatives of these; (C12-C22) alkyl esters or (C12-C22) ethers of polypropylene glycol; (C12-C22) alkyl esters or (C12-C22) ethers of polypropylene glycol/polyethylene glycol copolymer; and polyether polysiloxane copolymers, cyclic dimethicones, including volatile cyclic silicones such as D3 and D4, polydialkylsiloxanes, polyaryl/alkylsiloxanes, silicone copolyols, long chain (i.e., C8-C36) alkyl and alkenyl esters of long (i.e., C8-C18) straight or branched chain alkyl or alkenyl alcohols or acids, long chain (i.e., C8-C36) alkyl and alkenyl amines or acids; hydrocarbons including straight and branched chain alkanes and alkenes such as isoparafins (e.g., isooctane, isododecane, isooctadecane, etc.), squalene, and mineral oil, polysiloxane polyalkylene copolymers, dialkoxy dimethyl polysiloxanes; (C12-C22) alkyl and (C12-C22) alkenyl alcohols, and petroleum derived alkanes such as isoparafins petrolatum, petrolatum USP, as well as refined natural oils (especially NF or USP grades) such as olive oil NF, cotton seed oil, peanut oil, corn oil, sesame oil, safflower oil, soybean oil, and the like, and blends thereof. In certain preferred embodiments, the hydrophobic components useful in the compositions of the present invention include those selected from the group consisting of petrolatum USP and short chain (C1-C6) alkyl or C6-C12) aryl esters of long (i.e., C8-C36) straight or branched chain alkyl or alkenyl alcohols or acids and polyethoxylated derivatives of the alcohols; short chain (i.e., C1-C6) alkyl or (C6-C12) aryl esters of (C4-C12) diacids or diols optionally substituted in available positions by —OH (such as diisopropyladipate, diisopropylsebacate); (C1-C9) alkyl or (C6-C12) aryl esters of glycerol, pentaerythritol, ethylene glycol, propylene glycol (such as glyceryl tricaprylate/caprate); glycerol triacetate (Triacetin); alkyl citrates (e.g. triethyl citrate (TEC), acetyle triethyl citrate (ATEC), tributyl citrate (TBC), acetyl tributyl citrate (ATBC), tri-(2-ethylhexyl) citrate (TOC), acetyle trioctyl citrate (ATOC), trihexyl citrate (THC), acetyl trihexyl citrate (ATHC), butyryl trihexyl citrate (BTHC, trihexyl o-butyryl citrate)); epoxidized soybeal oil (ESBO or ESO), epoxidized linoleic oil (ELO); and a combination thereof. In some embodiments, hydrophobic compounds may be present in an amount of about 0 wt % to about 90 wt %. For example, one or more hydrophobic compound may be present in amount in wt % of about 0, 5, 10, 15, 20, 25, 30, 40, 50, 60, 70, 80, or 90, or a value within a range between any of the preceding values, e.g., between about 5 and about 10, between about 50 and about 60, or the like.

In some embodiments, the antimicrobial composition may further include a secondary antimicrobial. In some embodiments, the secondary antimicrobial may be selected from a cationic antimicrobial, a nonionic antimicrobial, and a combination thereof. In other embodiments, the antimicrobial composition may exclude secondary antimicrobials. In some embodiments, the antimicrobial composition may exclude secondary cationic antimicrobials. In some embodiments, the antimicrobial composition may exclude secondary nonionic antimicrobials. All embodiments described herein exclude anionic antimicrobials. Exemplary secondary antimicrobials include phenolic antiseptics such as parachlorometaxylenol (PCMX), triclosan, hexachlorophene, and others disclosed in U.S. Pat. No. 8,198,326 (the contents of which are incorporated by reference herein in its entirety); antimicrobial lipids; fatty acid monoesters of glycerin and propylene glycol such as glycerol monolaurate, glycerol monocaprylate, glycerol monocaprate, propylene glycol monolaurate, propylene glycol monocaprylate, propylene glycol moncaprate, C₈-C₁₂ alkyl monoethers of glycerin and propylene glycol such as 2-ethylhexyl glycerin ether (available from Schuelke Mayr, Norderstedt, Germany, under the trade designation “SENSIVA SC 50”) as well as other antimicrobial lipids disclosed in U.S. Pat. Pub. No. 2005-0058673 (the contents of which are incorporated by reference herein in its entirety); natural oil antiseptics disclosed in U.S. Patent Publication No. 2006/0051384 (the contents of which are incorporated by reference herein in its entirety); C₆-C₁₂ alkyl and aryl carboxylic acids; quaternary silanes; silver; silver salts such as silver chloride, silver oxide silver sulfadiazine; copper; copper salts; iodophors; and combinations thereof.

In some embodiments, the antimicrobial composition may include one or more secondary antimicrobial selected from glycol alkylethers (i.e., monoglycols or polyglycols monoetherified or dietherified with C₁₋₂₅ alkyl), glycol alkylesters (i.e., monoglycols or polyglycols monoesterified or diesterified with C₁₋₂₅ alkyl), polyglycerin, glyceryl alkylethers (i.e., monoglyceryl of polyglyceryls etherified with C₁₋₂₅ alkyl), glyceryl alkylesters (i.e., monoglyceryl of polyglyceryls esterified with C₁₋₂₅ alkyl), alkanediols (i.e., alkanes having 1,2-diols, e.g., C₄₋₁₂ alkanes), alkanetriols, a combination thereof, or the like.

In some embodiments, the antimicrobial composition may include a secondary antimicrobial selected from 1,2-octanediol (i.e., C₈ alkanediol), ethylhexylglycerin (i.e., monoglyceryl etherified with branched C₈ alkyl), propylene glycol monocaprylate (i.e., a polyglycol esterified with a C₇ alkyl), and a combination thereof. In some embodiments, a secondary antimicrobial may be present in a total amount of about 0 wt % to about 5 wt % with respect to the weight of the antimicrobial composition. For example, an the secondary antimicrobial may be present in a total amount in wt % of about 0.0, 0.02, 0.05, 0.10, 0.25, 0.5, 0.75, 1.0, 1.25, 1.5, 1.75, 2.0, 2.25, 2.50, 2.75, 3.0, 3.25, 3.5, 3.75, 4.0, 4.25, 4.5, 4.75, or 5.0, or a value within a range between any of the preceding values, e.g., between about 2.5 and about 3.0, between about 0.75 and about 1.5, or the like. In some embodiments, the antimicrobial composition may include octenidine salt and a secondary antimicrobial present in a wt % ratio of about 10:1 to about 1:10. For example, octenidine salt and a secondary antimicrobial may be present in a wt % ratio of about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10, or a ratio between any of the preceding values, e.g., between about 10:1 and about 8:1, between about 6:1 and about 1:1, or the like.

In some embodiments, the antimicrobial composition may further include a viscosity modifying agent. In some embodiments, a viscosity modifying agent may be selected from ethylcellulose, hydroxyethyl cellulose, hydroxypropyl methylcellulose, (e.g., METHOCEL™ from Dupont, Hydroxypropyl Guar), and a combination thereof. Viscosity modifying agents may be present in an amount depending upon the desired viscoelasticity.

In some embodiments, the antimicrobial composition may further include a surfactant. In some embodiments, the surfactant may be selected from a non-ionic surfactant, a cationic surfactant, a zwitterionic surfactant, and a combination thereof. In some embodiments, the antimicrobial composition may exclude anionic surfactant(s). Exemplary cationic surfactants include, for example, dimethyl distearyl ammonium chloride and behenyl trimethyl ammonium methosulfate (available from Croda USA). Exemplary nonionic surfactants include, for example, alkyl glucosides, alkyl polyglucosides, polyhydroxy fatty acid amides, sucrose esters, esters of fatty acids and polyhydric alcohols, fatty acid alkanolamides, ethoxylated fatty acids, ethoxylated aliphatic acids, ethoxylated fatty alcohols (e.g., octyl phenoxy polyethoxyethanol available under the trade name TRITON and nonyl phenoxy poly(ethyleneoxy) ethanol available under the trade name NONIDET, both from Sigma, St. Louis, Mo.), ethoxylated and/or propoxylated aliphatic alcohols (e.g., that available under the trade name Brij from ICI), ethoxylated glycerides, ethoxylated/propoxylated block copolymers such as the Pluronic and Tetronic surfactants available from BASF, ethoxylated/propoxylated block copolymer ethers such as the POLAWAX™ COSMOWAX™ and CROTHIX™ as well as (INCROQUAT™ Behenyl TMS) systems from Croda Inc., ethoxylated cyclic ether adducts, ethoxylated amide and imidazoline adducts, ethoxylated amine adducts, ethoxylated mercaptan adducts, ethoxylated condensates with alkyl phenols, ethoxylated nitrogen-based hydrophobes, ethoxylated polyoxypropylenes, polymeric silicones, fluorinated surfactants (e.g., those available under the trade names FLUORAD, 3M Company, St. Paul, Minn., and ZONYL from Dupont de Nemours Co., Wilmington, Del.), polyglycerylesters of fatty acids such as those sold by Abitec Janesville Wis. under the Caprol tradename (e.g., polyglyceryl 10 decastearate), and polymerizable (reactive) surfactants (e.g., SAM 211 (alkylene polyalkoxy sulfate) surfactant available under the trade name MAZON from PPG Industries, Inc., Pittsburgh, Pa.).

In some embodiments, the antimicrobial composition may be characterized by a viscosity of about 20 centipoise (cps) to about 500,000 cps. For example, the antimicrobial composition may be characterized by a viscosity in cps of about 20, 50, 100, 250, 500, 1000, 5000, 10,000, 15,000, 20,000, 25,000, 30,000, 40,000, 50,000, 75,000, 100,000, 125,000, 150,000, 175,000, 200,000, 225,000, 250,000, 275,000, 300,000, 325,000, 350,000, 375,000, 400,000, 425,000, 450,000, 475,000, or 500,000, or a value within a range between any of the preceding values, e.g., between about 10,000 and about 20,000, between about 50,000 and about 250,000, or the like. The viscosity may be measured at approximately 22° C. at ambient pressure using a Brookfield LVDV-G viscometer equipped with a model D Brookfield heliopath and LV spindles. The spindle and speed may be chosen for each particular sample such that the viscometer is operating in the middle of its range. All samples are allowed to equilibrate at approximately 22° C. for 24 hours prior to measurement. Preferably the viscosity is taken at the lowest speed possible while staying within 20-80% of the viscometer range and more preferably between 30-70% of the range. In all cases the sample size and container geometry are chosen to ensure that there are no wall effects. By “wall effects” it is meant the viscosity value is not affected by the container and is essentially equivalent to the viscosity taken in an infinitely large container. For this reason, lower viscosity samples may require a larger sample size to accommodate the larger spindles. The viscosity of each sample is taken as the highest relatively stable reading achieved on the first path the spindle traverses using the heliopath adapter.

In some embodiments, the antimicrobial composition may further include an organic solvent. Organic solvents may aid in solubilizing composition components or otherwise aid in formulation. In some embodiments, suitable organic solvents include solvents have a boiling point less than about 90° C. Exemplary organic solvents include methanol, ethanol, and the like. Typically, organic solvents may be present in an amount from about 0 to about 10 wt %. For example, an organic solvent may be present in an amount in wt % with respect to the weight of the composition of about 0, 0.2, 0.6, 0.8, 1, 1.5, 2.0, 2.5, 3.0, 3.5, 4.0, 4.5, 5.0, 5.5, 6.0, 6.5, 7.0, 7.5, 8.0, 8.5, 9.0, 9.5, or 10, or a value within a range between any of the preceding values, e.g., between about 0.2 and about 1, between about 2.0 and about 2.5, or the like.

In some embodiments, the antimicrobial composition may further include a water-soluble (at least 5 wt % soluble in water at 23° C.) polymer or water-dispersible polymer characterized by a T_{g} of at least 20° C. The polymer may function to transform the composition into a cohesive shape, e.g., a film. Antimicrobial films may help to maintain a moist environment surrounding a wound and may even absorb wound exudate, thereby facilitating healing. For example, suitable water-soluble or water-dispersible polymers include polyvinylpyrrolidone, a polyvinyl alcohol, butyene diol vinyl alcohol and its copolymers, polysaccharides such as starch, guar gum, locust bean gum, carrageenan, hyaluronic acid, agar, alginate, tragacanth, gum arabic, gum karraya, gellan, and xanthan gums as well as modifications of these such as hydroxyethyl-, hydroxypropyl-, or cationic derivatives; a modified cellulose polymer (e.g., hydroxyethylcellulose, hydroxypropyl methylcellulose, carboxymethylcellulose, cationic cellulose such as polyquaterium 4, and the like), a copolymer of polyvinylpyrrolidone and vinyl acetate, water soluble and water swellable polyacrylates (e.g. based on hydroxyethylacrylate, hydroxypropyl acrylate, acrylic acid, acrylamide, PEG acrylates, methyl acrlayte, methacrylates, and the like) and a combination of any two or more of the foregoing water-soluble or water-dispersible polymers. In certain embodiments, the water-soluble or waterdispersible polymers can comprise a polyquatemium polymer. In some embodiments, the antimicrobial composition may include a water-soluble or water-dispersible polymer present in an amount of about 5 wt % to about 65 wt % based upon the weight

In some embodiments, the antimicrobial composition may be characterized by a pH of at least 3 and no greater than 4.5. For example, the antimicrobial composition may be characterized by a pH of about 3, 3.1, 3.2, 3.3, 3.4, 3.5, 3.6, 3.7, 3.8, 3.9, 4.0, 4.1, 4.2, 4.3, 4.4, or 4.5, or a value between any of the preceding values, e.g., between about 3.3 and about 4.0, between about 3.5 and about 3.8, or the like. In some embodiments, the antimicrobial composition may include one or more buffer (e.g., an acid and/or a base) to adjust the pH of the antimicrobial composition. All buffers known in the art are suitable.

In some embodiments, the antimicrobial composition may include octenidine hydrochloride and carnitine tartrate present in a wt % ratio of about 1:10 at a pH of less than about 4.3. In some embodiments, the antimicrobial composition may include octenidine hydrochloride in an amount of at least 0.2 wt %, carnitine tartrate in an amount of at least 2 wt %. In some embodiments, the antimicrobial composition may include octenidine hydrochloride in an amount of at least 0.5 wt % and carnitine tartrate in an amount of at least 5 wt %.

In some embodiments, the antimicrobial composition may be effective in reducing the presence of various microorganisms on a surface in which the antimicrobial composition contacts. For example, the antimicrobial composition is effective against Pseudomonas aeruginosa at a log reduction of at least 4 over a period of contact of about 60 minutes as evaluated by the Antimicrobial Efficacy Test described herein. In some embodiments, the antimicrobial composition may be effective in reducing MRSA at a log reduction of at least 4 over a period of contact of about 60 minutes as evaluated by the Antimicrobial Efficacy Test described herein.

### Antimicrobial Articles

In many embodiments, an antimicrobial article is described. The antimicrobial article may include a substrate and an antimicrobial composition described herein disposed on or within the substrate.

In some embodiments, the substrate may be selected from a fibrous material, a foam, a sheet material, a nonwoven material, a woven material, a solid polymeric material, a polymeric film, plastic, paper, molded fiber, rubber, glass ceramic, metal, metal foil, a medical device surface, or a combination thereof.

In some embodiments, the antimicrobial article may be a wound bandage, wrap, dressing, or the like.

In some embodiments, the antimicrobial article may be a tape.

In some embodiments, the antimicrobial article may be a surgical incise drape.

In some embodiments, the antimicrobial article may be an intravenous dressing, a paracentesis dressing, or the like.

In some embodiments, the antimicrobial article may be a cloth, sponge, foam, nonwoven, paper product, swab, wipe, or the like.

### Methods for Preventing or Treating an Infection

In many embodiments, a method for preventing an infection or treating an infection in a subject is described. The method may include contacting an antimicrobial composition described herein or an antimicrobial article described herein to a body surface and allowing the antimicrobial composition to contact the body surface for a period effective to reduce the presence of infection-promoting microorganisms.

In some embodiments, the body surface may be a skin surface. In some embodiments, the skin surface may be an intact. A user may contact an intact skin surface with an antimicrobial composition or antimicrobial article to disinfect the skin surface, especially prior to intentionally compromising the skin surface, e.g., surgery, needle, abrasives, grafting, or the like. In other embodiments, the skin surface may be a broken, i.e., a wound. Contacting the antimicrobial composition or antimicrobial article to a broken skin surface is intended to further include the antimicrobial composition coming in contact with the tissues beneath the skin surface. In some embodiments, a user may be further instructed to directly apply the antimicrobial composition or antimicrobial article to exposed tissues within a wound. In some embodiments, a user may be directed to insert an antimicrobial composition or antimicrobial article into a wound. Many conditions may be treated with the antimicrobial compositions described herein, e.g., conditions of the skin such as impetigo, eczema, psoriasis, rosacea, and diaper rash in infants and incontinent adults, inflammation around ostomy devices, shingles, infections within cuts, chronic otitis media, infections of the vagina or rectum, yeast infections, bacterial rhinitis, ocular infections, cold sores, genital herpes, colonization of Staphylococcus aureus in the anterior nares (e.g., prior to surgery or hemodialysis), mucositis, chronic sinusitis, rhinosinusitis, chronic colitis, Crohn's disease, burns, napkin rash, tinea pedis, tinea curis, tinea corporis, candidiasis, strep throat, strep pharyngitis, common colds, respiratory afflictions (e.g., asthma, pneumonia), and the like. In many embodiments, the method may treat any condition associated with colonization of bacteria, viruses, fungi, protozoa, or yeast.

In some embodiments, the body surface may include a mucosal lining, e.g., nasal or sinus cavity, anterior nares, nasopharynx, middle ear, eustachian tube, tympanic membrane, throat, esophagus, ocular orifice, ear canal, vaginal orifice, urethra, ocular orifice, oral cavity, or the like. Decolonizing a nasal cavity, for example, may further be effective in preventing transfer or transmission of microorganisms to other areas of the subject (e.g., during surgery) or even to others (e.g., sneezing).

In some embodiments, the body surface may include an internal body cavity, e.g., bladder, stomach, peritoneal cavity, uterus, or the like. For example, a catheter may be contacted with an antimicrobial composition or an antimicrobial article prior to insertion, wherein the inserted catheter may be in contact with at least a portion of the bladder.

In some embodiments, the contacting may be effective to reduce the number of Gram positive bacteria, Gram negative bacteria, fungi, protozoa, mycoplasma, yeast, viruses, and even lipid-enveloped viruses. In some embodiments, the contacting may be effective to reduce the number of microorganisms selected from Staphylococcus spp., Streptococcus spp., Pseudomonas spp., Enterococcus spp., Esherichia spp., Aspergillus spp., Fusarium spp., and Candida spp., herpes virus, and a combination thereof. In some embodiments, the contacting may be effective in reducing the number of microorganisms selected from Staphylococcus aureus (including resistant strains such as Methicillin Resistant Staphylococcus Aureus (MRSA), Staphylococcus epidermidis, Streptococcus pneumoniae, Enterococcus faecalis, Vancomycin Resistant Enterococcus (VRE), Pseudomonas aeruginosa, Escherichia coli, Aspergillus niger, Aspergillus fumigatus, Aspergillus clavatus, Fusarium solani, Fusarium oxysporum, Fusarium chlamydosporum, Candida albicans, Candida glabrata, Candida krusei, and a combination thereof.

In some embodiments, the contacting may be effective in reducing the presence of microorganism, e.g., Pseudomonas aeruginosa, MRSA, or the like, at a log reduction of at least 4 over a period of contact of about 60 minutes as evaluated by the Antimicrobial Efficacy Test described herein. In some embodiments, the contacting may be effective in maintaining a log reduction of at least 1 log for at least 30 min.

### Methods for Disinfecting a Surface

In many embodiments, a method for disinfecting a surface is described. The method may include contacting an antimicrobial composition described herein or an antimicrobial article described herein to a surface and allowing the antimicrobial composition to contact the surface for a period effective to reduce the presence of microorganisms.

In some embodiments, the contacting may be effective to reduce the number of Gram positive bacteria, Gram negative bacteria, fungi, protozoa, mycoplasma, yeast, viruses, and even lipid-enveloped viruses, including for example, any of the microorganism genera and species listed herein.

In some embodiments, the surface may be a medical device surface. For example, the surface may be a stethoscope, an arm cuff, a probe, forceps, a catheter, a needle, a knife, an oxygen mask, nasal cannula, or the like.

In some embodiments, the surface may be a medical setting surface. For example, the surface may include surfaces within a hospital, e.g., desks, computers, machines, toilets, bed frames, floor tiles, countertops, tubs, dishes, gloves, or the like.

In some embodiments, the surface may be a body surface. While disinfecting a body surface (i.e., decolonizing a surface) may prevent an infection, there is no need to determine if an infection was prevented by the method of disinfecting or decolonizing.

### Kits

In many embodiments, a kit is described. The kit may include an antimicrobial composition described herein and a set of instructions directing a user to conduct a method described herein.

In many embodiments, a kit is described. The kit may include an antimicrobial article described herein and a set of instructions directing a user to conduct a method described herein.

In many embodiments, a kit is described. The kit may include an octenidine salt (e.g., octenidine hydrochloride) and carnitine tartrate provided together as a powder or a concentrate, and a set of instructions directing a user to contact the powder or concentrate with water to form an antimicrobial composition described herein. In some embodiments, the kit may include a powder consisting essentially of an octenidine salt and carnitine tartrate. In some embodiments, a concentrate may include one or more emollient, humectant, viscosity modifying agent, pH buffer, and surfactant. In some embodiments, a concentrate may include water in an amount in wt % less than 1, 0.8, 0.6, 0.4, 0.2, 0.1, 0.08, 0.06, 0.04, 0.02, 0.01, 0.005, or 0.001, or a value within a range between any of the preceding values.

In some embodiments, the kit may further include an applicator. For example, the kit may include a wipe, a swab, a sponge, wrap, bandage, gauze, or the like.

### EXAMPLES

Objects and advantages of this disclosure are further illustrated by the following examples, but the particular materials and amounts thereof recited in these examples, as well as other conditions and details, should not be construed to unduly limit this disclosure. These examples are merely for illustrative purposes only and are not meant to be limiting on the scope of the appended claims.

Materials

| Ingredient | Name | Supplier |
|---|---|---|
| water | Water | Rocky Mountain |
| (sterile) | | Biologicals, Inc. |
| | | Missoula, Montana |
| glycerol | glycerol | Cargill Corporation, |
| | | Wayzata, MN |
| hydroxyethyl cellulose | Natrosol 250 HHX | Ashland |
| sodium hydroxide | NaOH | VWR, Radnor, PA |
| (50% in water) | | |
| hydrochloric acid 1N | HCl | VWR |

Antimicrobials

| | | |
|---|---|---|
| octenidine hydrochloride | octenidine | Alfa Aesar |
| chlorhexidine gluconate | CHG | Sigma Aldrich |
| polyhexamethylene | PHMB | Lonza |
| biguanide | | |
| benzyl ammonium chloride | BAC | Novo Nordisk |

Enhancers

| | | |
|---|---|---|
| L-Carnitine-L-Tartrate | Carnitine tartrate | Bulk Supplements |
| Carnitine Inner Salt | Carnitine Inner salt | Sigma |
| | (“Carnitine”) | |
| L-Carnitine fumarate | Carnitine fumarate | Bulk Supplements |
| Acetyl L-Carnitine | Acetyl carnitine | Bulk Supplements |

### Methods

### Octenidine and Carnitine-Based Enhancers

Water and the carnitine enhancer (i.e., carnitine inner salt, carnitine tartrate tartaric acid, carnitine fumarate, or acetyl carnitine) to a 20 mL glass vial mixed with magnetic stirring. Octenidine hydrochloride (10% solution in 50:50 weight percentage methanol:water) was further added in the amount described in the tables below. The pH was adjusted using 1N HCL or NaOH. Glycerol (3 g) and Natrosol 250 HHX (3 g) were added to a flask and mixed with a DAC 400 FVZ SPEEDMIXER dual asymmetric centrifuge mixer (from Flacktek, Inc Landrum, S.C.) at 2500 rpm for 30 seconds. The glycerol and Natrosol 250 HHX (1.3 g) were combined with the enhancer solution in a 40 gms Flack Tec cup and mixed for an additional 30 seconds at 2500 rpm. The resulting solutions were homogenous. Refer to Examples 1-36 below (total weight percentages of octenidine hydrochloride and carnitine enhancer within composition are provided in tables; glycerol about 8-9 wt %; Natrosol 250 HHX about 2-3 wt %; and water makes up the difference). The solutions of Examples 1-27 below were subjected to antimicrobial testing according to the method below. The mixtures of Examples 28-36 were not subjected to antimicrobial testing because octenidine precipitated from solution.

As described above, aqueous compositions including only octenidine hydrochloride and a respective enhancer were also prepared (i.e., absent glycerol and Natrosol 250 HHX), similar to the formulations described in Tables 1-5. All compositions formed homogenous solutions. Antimicrobial testing was not performed on these compositions due to experimental difficulties in maintaining a composition of such low viscous on a sample surface. However, there is no reason to believe that such compositions would not work provide similar antimicrobial activities as the higher viscosity compositions in Tables 1-5. Aqueous solutions of low viscosity would be well-suited as wound-washing compositions.

### Other Antimicrobials and Carnitine-Based Enhancers

Solutions of water, carnitine enhancer, and various other antimicrobials (i.e., chlorhexidine gluconate, benzalkonium chloride, polyhexamethylene biguanide) were prepared according to the procedure described immediately above. Refer to Examples 37-45 below. The solutions of Examples 37-45 below were subjected to antimicrobial testing according to the method below.

### Test Method for Antimicrobial Activity (Antimicrobial Efficiency Test)

### Tissue Preparation

Ex vivo porcine mucosa is transported to laboratory on ice pack and then trimmed and transferred in to RPMI 1640+2% PS media. A 5 mm biopsy punch is used to cut samples for assay. Remove most of the remaining muscle tissue with a fresh scalpel blade. Rinse 3× with 10±0.5 ml RPMI no ABX, no FCS. Transfer to incubator. Set up a 6 well plate with 1.5±0.2 mL RPMI (no ABX, no FCS) in each well and a 0.4 μm transwell insert. Transfer tissue explants mucosal side up to the insert (3 explants/well).

Bacteria Preparation: Methicillin-Resistant Staphylococcus aureus and Pseudomonas Aeruginosa

Methicillin-resistant Staphylococcus aureus: Streak a fresh plate directly from frozen stock within three weeks of experiment. Inoculate culture tube containing Todd Hewitt broth (THB) with single colony and place in shaking incubator, (37±2° C., 200±50 rpm) late afternoon day before experiment.

Pseudomonas aeruginosa: Streak afresh plate directly from frozen stock within three weeks of experiment. Inoculate culture tube containing Todd Hewitt broth (THB) with single colony and place in shaking incubator, (37±2° C., 200±50 rpm) late afternoon day before experiment.

Passage overnight culture 1:10 into THB and return to shaking incubator for 2-3 hours. Remove 1 mL of passage culture from test tube and place in sterile microcentrifuge tube. Centrifuge (1±0.5 min at max speed) to pellet. Wash pellet with 1±0.1 mL RPMI, no ABX, no FCS. Centrifuge to pellet and re-suspend in 1±0.1 mL fresh RPMI. Check OD 600 to determine bacterial density and dilute as necessary to achieve ˜1E8 CFU/ml. Add bacteria: 2±1 μl per explant and return to incubator to infect 4±0.15 h.

### Treatment and Sampling

Apply 50± μl of formulation per explant (mucosa side). Incubate at 37±2° C. for 24±0.5 h.

Remove tissue from transwells and place in appropriate neutralizer. Sonicate samples and vortex (30±5 second vortex, 2±0.1 minutes sonicate, and then 30±5 second vortex). Plate on Mannitol Salt Agar selective agar or Blood Agar at appropriate dilution and store dilutions at 4±2° C. The following day count plates and if TNTC, re-plate at higher dilution.

### Examples 1-11: Octenidine and Carnitine Enhancers Against Methicillin-Resistant Staphylococcus aureus

Table 1 illustrates that octenidine solutions with a carnitine enhancer selected from carnitine inner salt and carnitine tartrate have greater activity against MRSA than do octenidine solutions without a carnitine enhancer. Table 1 further illustrates that solutions of carnitine inner salt, carnitine tartrate, or tartaric acid (i.e., without octenidine) do not provide adequate antimicrobial activities.

TABLE 1

| | | | Enhancer | | Log | Standard |
|---|---|---|---|---|---|---|
| EX | Octenidine wt % | Enhancer | wt % | pH | Remaining* | Deviation** |
| 1 | 0.425 | None | — | 4.5 | 8.26 | 0.37 |
| 2 | 0.423 | Carnitine | 4.24 | 7.16 | 6.96 | 0.20 |
| 3 | 0.420 | Carnitine | 4.18 | 5.11 | 6.09 | 0.68 |
| 4 | 0.423 | Carnitine tartrate | 4.23 | 4.03 | 0.00 | 0.00 |
| 5 | 0.281 | Carnitine tartrate | 2.81 | 4.32 | 0.00 | 0.00 |
| 6 | None | Carnitine | 4.42 | 7.26 | 8.78 | 0.14 |
| 7 | None | Carnitine | 4.37 | 5.12 | 8.84 | 0.05 |
| 8 | None | Carnitine tartrate | 4.42 | 3.66 | 8.66 | 0.07 |
| 9 | None | Carnitine tartrate | 2.90 | 3.97 | 8.90 | 0.15 |
| 10 | None | Tartaric acid | 2.17 | 3.5 | 8.73 | 0.22 |
| 11 | None | Tartaric acid | 2.17 | 4 | 8.97 | 0.06 |

*Growth control value = 8.004
**Growth control standard deviation = 0.23

### Examples 12-27: Octenidine and Carnitine Enhancers Against Pseudomonas aeruginosa

Table 2 illustrates that solutions (at pH<4.3) having a combination of octenidine and carnitine tartrate show significantly greater antimicrobial activity against Pseudomonas aerguinosa than do solutions having octenidine or carnitine tartrate alone.

TABLE 2

| | | | Enhancer | | Log | Standard |
|---|---|---|---|---|---|---|
| EX | Octenidine wt % | Enhancer | wt % | pH | Remaining* | Deviation** |
| 12 | 0.5 | None | 0 | 6.48 | 7.85 | 0.82 |
| 13 | 0.5 | Carnitine tartrate | 5 | 3.51 | 1.53 | 2.66 |
| 14 | 0.5 | Carnitine tartrate | 10 | 3.53 | 0.00 | 0.00 |
| 15 | None | Carnitine tartrate | 5 | 3.52 | 8.61 | 0.27 |

*Growth control value = 8.46
**Growth control standard deviation = 0.05

Table 3 illustrates that octenidine solutions (pH<4.3) having less than 2 wt % were not as effective. Table 3 further illustrates that octenidine solutions (pH>4.3) having greater than 2 wt % were not as effective.

TABLE 3

| | | | Enhancer | | Log | Standard |
|---|---|---|---|---|---|---|
| EX | Octenidine wt % | Enhancer | wt % | pH | Remaining* | Deviation** |
| 16 | 0.42 | Carnitine tartrate | 1.69 | 3.68 | 8.14 | 0.45 |
| 17 | 0.42 | Carnitine tartrate | 1.69 | 4 | 6.88 | 1.40 |
| 18 | 0.42 | Carnitine tartrate | 1.69 | 5.75 | 8.00 | 0.74 |
| 19 | 0.42 | Carnitine tartrate | 4.24 | 4.55 | 7.67 | 0.73 |
| 20 | None | Carnitine tartrate | 4.40 | 4.5 | 8.98 | 0.02 |
| 21 | 0.42 | Carnitine tartrate | 4.22 | 4.5 | 8.27 | 0.26 |
| 22 | None | Carnitine tartrate | 4.39 | 5.5 | 8.88 | 0.17 |
| 23 | 0.42 | Carnitine tartrate | 4.21 | 5.5 | 8.37 | 0.19 |
| 24 | None | Carnitine tartrate | 8.77 | 4.5 | 8.40 | 0.50 |
| 25 | 0.42 | Carnitine tartrate | 8.40 | 4.5 | 5.05 | 1.97 |
| 26 | None | Carnitine tartrate | 8.73 | 5.5 | 8.79 | 0.11 |
| 27 | 0.42 | Carnitine tartrate | 8.36 | 5.5 | 7.21 | 0.37 |

*Growth control value = 7.90
**Growth control standard deviation = 0.20

### Examples 28-36: Unsuitable Carnitine Enhancers

Compositions with octenidine and carnitine fumarate or acetyl carnitine failed to provide a homogenous solution in that octenidine complex precipitated. The compositions are described in Table 4. It is not clear why carnitine tartrate works well while other carnitine species do not. It was also observed that octenidine precipitated in a solution with tartaric acid instead of enhancer.

TABLE 4

| | Octenidine | | Enhancer | |
|---|---|---|---|---|
| EX | wt % | Enhancer | wt % | pH |
| 28 | 0.5 | Carnitine Fumarate | 5 | 3.22 |
| 29 | 0.5 | Carnitine Fumarate | 5 | 3.94 |
| 30 | 0.5 | Carnitine Fumarate | 5 | 5.37 |
| 31 | 0.5 | Carnitine Fumarate | 2 | 3.22 |
| 32 | 0.5 | Carnitine Fumarate | 2 | 4.43 |
| 33 | 0.5 | Carnitine Fumarate | 5 | 3.22 |
| 34 | 0.5 | Acetyl Carnitine | 5 | 5 |
| 35 | 0.5 | Acetyl Carnitine | 2 | 2.31 |
| 36 | 0.5 | Acetyl Carnitine | 2 | 4.04 |

### Examples 37-45: Other Antimicrobials with Carnitine Enhancers

Chlorhexidine gluconate, polyhexamethylene biguanidine, and benzalkonium chloride were tested for antimicrobial activity in the presence of carnitine enhancers. It was observed that chlorhexidine gluconate and polyhexamethylene biguanidine performed better in the absence of carnitine enhancer, suggesting that the carnitine enhancer inhibited antimicrobial activity. No effect was observed with benzalkonium chloride. The results are provided in Table 5.

TABLE 5

| | | Anti- | | | | | |
|---|---|---|---|---|---|---|---|
| | Anti- | microbial | | Enhancer | | Log | Standard |
| EX | microbial | Wt % | Enhancer | wt % | pH | Remaining* | Deviation** |
| 37 | CHG | 0.322 | Carnitine Tartrate | 3.215 | 4.057 | 7.08 | 1.39 |
| 38 | CHG | 0.431 | Carnitine | 4.310 | 5.517 | 7.78 | 0.92 |
| 39 | CHG | 0.452 | None | 0 | 6.566 | 6.14 | 2.81 |
| 40 | PHMB | 0.369 | Carnitine Tartrate | 3.690 | 4.018 | 5.93 | 2.35 |
| 41 | PHMB | 0.432 | Carnitine | 4.322 | 6.065 | 6.51 | 3.09 |
| 42 | PHMB | 0.452 | None | 0 | 7.024 | 4.94 | 2.92 |
| 43 | BAC | 0.111 | Carnitine Tartrate | 4.264 | 3.638 | 8.38 | 0.44 |
| 44 | BAC | 0.114 | Carnitine | 4.395 | 5.78 | 8.73 | 0.40 |
| 45 | BAC | 0.120 | None | 0 | 5.676 | 8.72 | 0.36 |

*Growth control value = 8.98
**Growth control standard deviation = 0.16

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims.

1. An antimicrobial composition comprising:
an octenidine salt;
carnitine tartrate; and
water.

2. The antimicrobial composition of claim 1, wherein the octenidine salt is octenidine hydrochloride.

3. The antimicrobial composition of claim 1, wherein the octenidine salt is present in an amount of about 0.05 wt % to about 20 wt % with respect to the weight of the composition.

4. The antimicrobial composition of claim 1, wherein the carnitine tartrate is present in an amount of about 0.05 wt % to about 50 wt % with respect to the weight of the antimicrobial composition.

5. The antimicrobial composition of claim 1, wherein the octenidine salt and the carnitine tartrate are present in a wt % ratio of about 10:1 to about 1:10.

6. The antimicrobial composition of claim 1, wherein the water is present in an amount of about 30 wt % to about 99 wt % with respect to the weight of the composition.

7. The antimicrobial composition of claim 1, further comprising a secondary antimicrobial selected from a cationic antimicrobial, a nonionic antimicrobial, and a combination thereof.

8. The antimicrobial composition of claim 7, the secondary antimicrobial selected from glycol alkylethers, glycol alkylesters, glyceryl alkylethers, glyceryl alkylesters, alkanediols, alkanetriols, and a combination thereof.

9. The antimicrobial composition claim 7, the secondary antimicrobial selected from 1,2-octanediol, ethylhexyl glycerin, propylene glycol monocaprylate, and a combination thereof.

10. The antimicrobial composition of claim 7, the secondary antimicrobial is present in a total amount of about 0.25 wt % to about 5 wt % with respect to the weight of the antimicrobial composition.

11. The antimicrobial composition of claim 7, wherein the octenidine salt and the secondary antimicrobial are present in a wt % ratio of about 1:10 to about 10:1.

12. The antimicrobial composition of claim 1, further comprising a viscosity modifying agent, a surfactant, or a combination thereof.

13. The antimicrobial composition of claim 12, the viscosity modifying agent selected from hydroxyethyl cellulose, hydroxypropyl methylcellulose, and a combination thereof; the surfactant selected from polyoxyethylene, polyoxypropylene, and a block polymer thereof.

14. (canceled)

15. (canceled)

16. (canceled)

17. The antimicrobial composition of claim 1, further comprising a water-soluble, water-swellable, or water-dispersible polymer.

18. (canceled)

19. The antimicrobial composition of claim 1, wherein the antimicrobial composition is in the form of a gel, a solution, a suspension, or a film and is characterized by a pH of at least 3 and no greater than 4.5.

20. (canceled)

21. (canceled)

22. (canceled)

23. An antimicrobial article comprising:
a substrate; and
an antimicrobial composition of claim 1 disposed on or within the substrate.

24. (canceled)

25. A method for preventing an infection or treating an infection in a subject, the method comprising:
contacting an antimicrobial composition of claim 1 to a body surface; and
allowing the antimicrobial composition to contact the body surface for a period effective to reduce the presence of infection-promoting microorganisms.

26. (canceled)

27. (canceled)

28. A method for disinfecting or decolonizing a surface, the method comprising:
contacting an antimicrobial composition of claim 1 to a surface; and
allowing the antimicrobial composition to contact the surface for a period effective to reduce the presence of microorganisms.

29. A kit comprising:
an antimicrobial composition of a claim 1; and
a set of instructions directing a user to contact a surface with the antimicrobial composition.

30. A kit comprising:
an octenidine salt and carnitine tartrate provided together as a powder or a concentrate; and
instructions directing a user to contact the powder or concentrate with water to form the antimicrobial composition of claim 1.
